(19) United States
(12) Patent Application Publication
(10) Pub. No.: US 2004/0052045 A1
(43) Pub. Date: Mar. 18, 2004

(54) Hard disk storage device incorporating dedicated user interface

(76) Inventor: Robert Botchek, Saratoga, CA (US)

Correspondence Address: ROBERT BOTCHEK, 3855 CHARTER POINT CT., BROOKFIELD, WI, 53045, US

(21) Appl. No.: 10/244,585

(22) Filed: Sep. 16, 2002

(51) Int. Cl. G06F 1/16

(52) U.S. Cl. 361/685

(57) ABSTRACT

A user interface and the logic for controlling said user interface are incorporated in the design of a hard disk storage device. The user interface provides a computer operator with passive and interactive means for monitoring the reliability and performance of the hard disk device. The user interface further provides a computer operator with means for configuring and troubleshooting the hard disk device.

In the preferred embodiment, the user interface incorporates a 2 line×20 character LCD display and a membrane keypad. The logic for controlling the LCD display and membrane keypad is integrated in the design of a bridge controller which adapts a standard ATA hard disk to connect to a host computer through an IEEE-1394 bus interface. The LCD display, membrane keypad, bridge controller, and ATA hard disk are mounted together in a custom external enclosure.

### FIELD OF INVENTION

The present invention relates generally to information storage devices used with digital computers and more particularly, to the addition of a user interface dedicated for use with such storage devices.

### BACKGROUND OF THE INVENTION

Hard disk drive information storage devices are central to the operation of contemporary computer systems. Such hard disk devices typically store data including the computer operating system, program files, and user data. This data is crucial to the proper operation of the computer and often represents the investment of considerable time on the part of the computer operator, in many cases representing man-years of work.

The data itself often outlives the computer system on which the data was originally created. When the computer operator upgrades to a new computer system it is very common for the operator to migrate data from the original computer system to the new computer system. In many cases this migration is effected by physically moving the hard disk storage device from the original computer to the new computer. In this way, a hard disk storage device will in many cases also outlive the original computer system in which it was first installed.

Given the importance of the data stored on such hard disk devices, computer operators generally attempt to protect the integrity of the data. One mechanism by which computer operators attempt to protect data integrity is to make copies of the data, termed backups, on secondary storage devices. In the past, alternate storage media such as tape and CD-ROM were large enough to serve as convenient and effective backups. However, hard disk device capacity has grown at a faster rate than the capacities of these alternate storage media. Consequently, alternate media such as tape and CD-ROM are often no longer adequate for the storage of data backups. Therefore, computer operators are increasingly using secondary hard disk storage devices as the media on which to create data backups.

A second mechanism by which computer operators attempt to protect data integrity is to monitor the reliability or health of their hard disk storage devices. Such monitoring is an attempt to detect or predict potential failures before such failures lead to the loss of data. While useful, adoption of such monitoring of hard disk reliability has been limited among the majority of computer operators due to several factors. Such monitoring often requires the addition of hard disk monitoring software on the computer system and the training of computer operators in the use of said software. Moreover, such monitoring software may not be available for a specific computer system, a specific computer operating system, or may not work with hard disks connected to the computer through a particular interface bus.

At the same time computer operators are seeking ways to protect data integrity the volume of data generated by computer applications has also grown at a rapid pace. Computer applications introduced in the past several years, including the capture and editing of multimedia data such as video and audio, are capable of producing enormous volumes of data. The storage requirements of this data often exceed the capacity of the primary hard disk installed in a computer system. Therefore, computer operators are also turning to secondary hard disk storage devices as the media on which to store the data generated by such computer applications.

The nature of the data stored on secondary storage devices often requires that it be shared with other computer operators. The requirement for sharing of data often leads users to select portable hard disk devices as the preferred embodiment of secondary hard disk devices. Such portable hard disk storage devices are installed in external enclosures, that is, enclosures separate from the computer system itself. Such external enclosures are connected to the computer using one of several interface buses. IEEE-1394, also known by Apple Computer's trade name FireWire and Sony Computer's trade name iLink, is one such interface bus. USB (Universal Serial Bus) and SCSI (Small Computer Systems Interface) are two other interface buses also used for this purpose.

Enclosures which employ the 1394 or USB interface buses typically include an ATA hard disk device and a 1394-ATA or USB-ATA bridge controller. Enclosures which employ the SCSI interface bus most often include SCSI hard disk devices. SCSI hard disk devices are often at least twice as expensive as comparable ATA hard disk devices for a given capacity, and this increase in SCSI hard disk device cost typically outweighs the cost of a 1394-ATA or USB-ATA bridge controller. Therefore, the bulk of contemporary external hard disk enclosures use the 1394 or USB interface buses.

Given the proliferation of secondary hard disk devices, computer operators also need convenient tools for configuring and troubleshooting the operation of such secondary hard disk devices. Given the portability of such hard disk devices, computer operators also need said tools to be available across a range of computer system platforms and operating system platforms. Such tools require an interactive user interface through which the computer operator accesses said tools.

Classically, secondary hard disk devices lack any form of user interface, except perhaps for a power LED (Light Emitting Diode) and an activity LED. Such LEDs provide only minimal information to the computer operator and do not provide for interactive control of the hard disk device. In a limited attempt to address this lack of information display capability, Iomega Corporation of San Diego, Calif., introduced an external storage device called the Peerless. The Peerless incorporates a small, segmented LCD (Liquid Crystal Display) to display limited status information to the computer operator, including several digits and a bar graph to indicate data transfer performance between the Peerless and the computer system. In case of abnormal operation, the digits could display a particular code to indicate an error to the user. The Peerless also incorporates a button which initiates the ejection of the media. The Peerless LCD, being a segmented LCD, cannot be reconfigured to display additional information beyond basic transfer performance and numeric operating codes.

U.S. Pat. No. 5,777,811 to Bodo (1998) presents a user interface for use with a digital data duplication system. Bodo describes a system which can perform the duplication of data from one information storage device to a second information storage device. The Bodo system is standalone and does not use a host computer system. Bodo incorporates an electronic circuit which controls the system, a computer program stored in ROM (Read Only Memory), an LCD display through which the system can present menus and status to the operator and a plurality of switches by which the operator can control the operation of the system.

In effect, Bodo presents an alternative to a personal computer system that is equipped with specialized data duplication software. In the Bodo alternative, the electronic circuit replaces the computer system, the computer program stored in ROM serves as specialized data duplication software, the LCD display replaces the computer monitor, and the plurality of switches replaces the computer keyboard. Bodo is a fixed-application system, designed only for the duplication of data from one information storage device to a second information storage device. Moreover, the Bodo system requires that said information storage devices be connected directly to the electronic circuit through information-storage-device connectors, rendering said information storage devices inaccessible to a host computer system.

In the absence of generally useful user interfaces on hard disk devices, computer hardware and software vendors have traditionally chosen to use the computer system's primary display, keyboard, and mouse to provide the user interface through which the computer operator controls specialized computer applications which can be used to configure and troubleshoot hard disk storage devices. This approach requires the development and deployment of such specialized computer applications for each computer system platform and each operating system platform on which such configuration and troubleshooting capabilities are to be used.

### SUMMARY OF THE INVENTION

An object of the present invention is to provide a system through which a computer operator can passively or interactively monitor a hard disk device in order to observe or predict the reliability of said hard disk device.

Another object of the present invention is to provide a system through which a computer operator can passively or interactively monitor hard disk performance.

Another object of the present invention is to provide a system through which a computer operator can interact directly with a hard disk device in order to configure or troubleshoot the operation of said hard disk device.

Another object of the present invention is to provide a system which neither requires nor precludes specialized computer applications running on a host computer in order to accomplish the aforementioned objectives.

Another object of the present invention is to provide a system in which it is possible to upgrade the capabilities and features available through the aforementioned user interface in units already in the field.

Briefly, the present invention is a hard disk enclosure integrating a dedicated user interface and a bridge controller capable of controlling said user interface while also controlling a hard disk device. Said hard disk device is a standard hard disk device, typically conforming to the ATA interface specification for hard disk devices. The bridge controller communicates with said hard disk device and communicates with a host computer system using an appropriate enclosure-to-computer bus interface, typically 1394 or USB.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a perspective view of an external hard disk enclosure illustrating the placement of a user interface in the preferred embodiment.

FIG. 2 is a perspective view illustrating the relative placement and connection of the user interface, a hard disk device, and a bridge controller in the preferred embodiment.

FIG. 3 is a block diagram illustrating major functional blocks and the connections between functional blocks in the preferred embodiment.

FIG. 4 is a flow chart of the operation of the CPU in the preferred embodiment.

### DETAILED DESCRIPTION OF THE PREFERRED EMBODIMENT

The present invention will now be described in detail with reference to a preferred embodiment thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to avoid unnecessarily obscuring the present invention.

The central element of the present invention is the incorporation of a user interface module and control logic in the design of a hard disk enclosure. The incorporation of said user interface and control logic provides a novel mechanism by which computer operators can interact directly with a hard disk device installed in the enclosure.

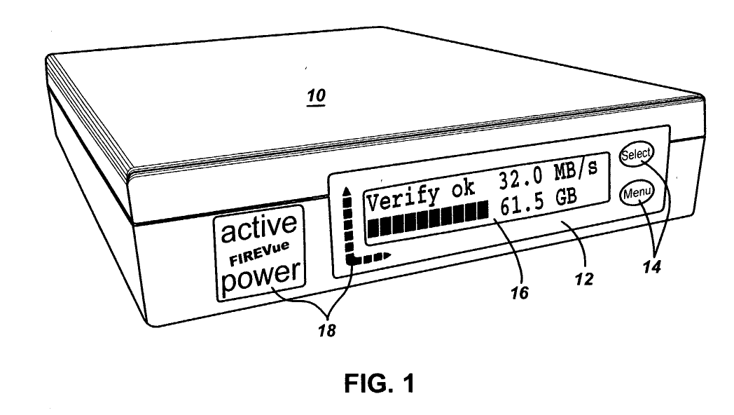

FIG. 1 illustrates a front perspective view of the preferred embodiment. In FIG. 1, a membrane keypad 12 incorporating buttons 14 is visible on the front face of a plastic enclosure 10. A viewing area on an LCD display 16 is visible through a clear window in membrane keypad 12. Graphic design elements 18 are non-functional.

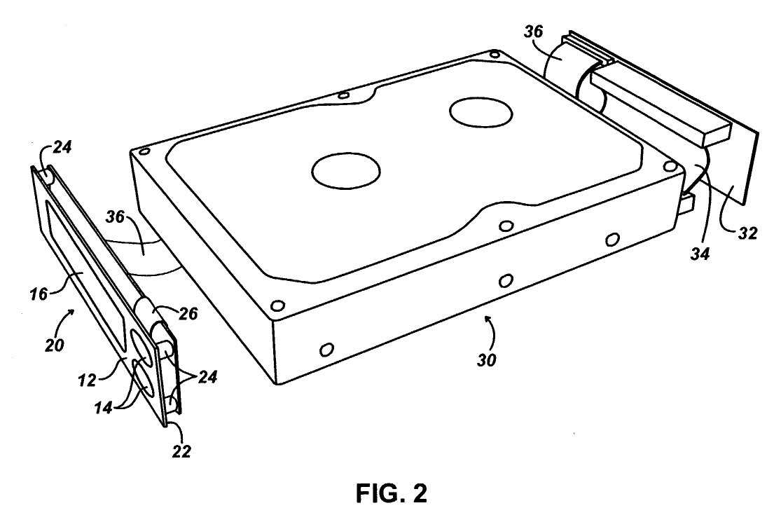

FIG. 2 illustrates a perspective view of a user interface module 20, a hard disk device 30, and a bridge controller 32 mounted inside plastic enclosure 10 (not shown in FIG. 2).

User interface module 20 incorporates plastic frame 22, membrane keypad 12, and LCD display 16. LCD display 16 is fabricated on a PCB (Printed Circuit Board) and is mounted to the rear of plastic frame 22 with screws (not shown) threaded into standoffs 24. In the preferred embodiment, LCD display 16 is a 2 line×20 position LCD alphanumeric character display module, part number HC4052BGHNY0462, from Densitron Corporation, Santa Fe Springs, Calif. In the preferred embodiment, plastic frame 22 and standoffs 24 comprise a single custom part formed by plastic injection molding.

Membrane keypad 12 is affixed to the front of plastic frame 22 with an adhesive backing. Membrane cable 26 connects a plurality of electrical signals from membrane keypad 12 to LCD display 16.

The plastic frame 22, membrane keypad 12, and LCD display 16 are designed so that the viewing area on LCD display 16 remains visible through the clear window in membrane keypad 12 after assembly.

Drive ribbon cable 34 connects a plurality of electrical signals from bridge controller 32 to hard disk device 30.

User interface cable 36 connects a plurality of electrical signals from bridge controller 32 to LCD display 16. The PCB on which LCD display 16 is fabricated has conductive traces (not shown) which conduct a subset of said plurality of electrical signals to membrane connector 26, and membrane connector 26 in turn conducts said subset of electrical signals to membrane keypad 12.

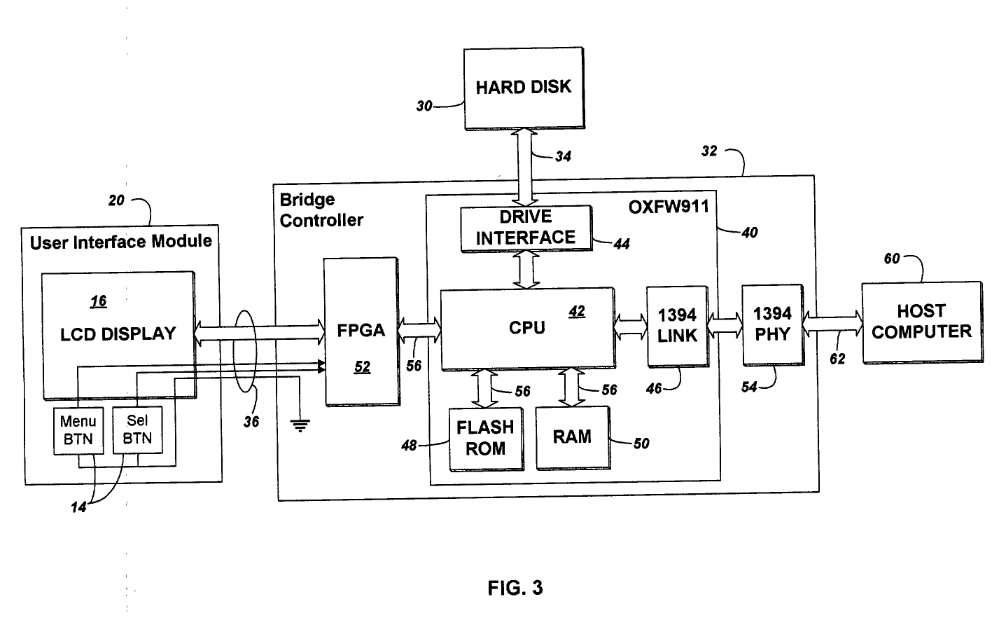

FIG. 3. is a block diagram illustrating major functional blocks and the connections between them in the preferred embodiment.

User interface module 20 comprising LCD display 16 and buttons 14 is controlled by an FPGA (Field Programmable Gate Array). In the preferred embodiment FPGA 52 is an EPM3032ATC44-10 from Altera Corporation, Santa Clara, Calif. FPGA 52 is connected to a CPU (Central Processing Unit) 42 through a CPU bus 56.

FLASH ROM 48 and RAM (Random Access Memory) 50 are also connected to CPU 42 through CPU bus 56. CPU 42 executes program code stored in FLASH ROM 48 and uses RAM 50 to store working data.

CPU 42 communicates with hard disk device 30 through drive interface 44. CPU 42 is connected to 1394 link 46 which is in turn connected to 1394 PHY (PHYsical interface) 54. Through 1394 link 46 and 1394 PHY 54, the CPU 42 is able to communicate with a host computer 60 over a 1394 interface bus 62.

In the preferred embodiment, CPU 42, drive interface 44, 1394 link 46, FLASH ROM 48, and RAM 50 are incorporated in a single integrated circuit 40. In the preferred embodiment, integrated circuit 40 is an OXFW911 from Oxford Semiconductor, Oxford, England. The 1394 PHY 54 is a TSB41LV02A from Texas Instruments, Dallas, Tex.

### OPERATION

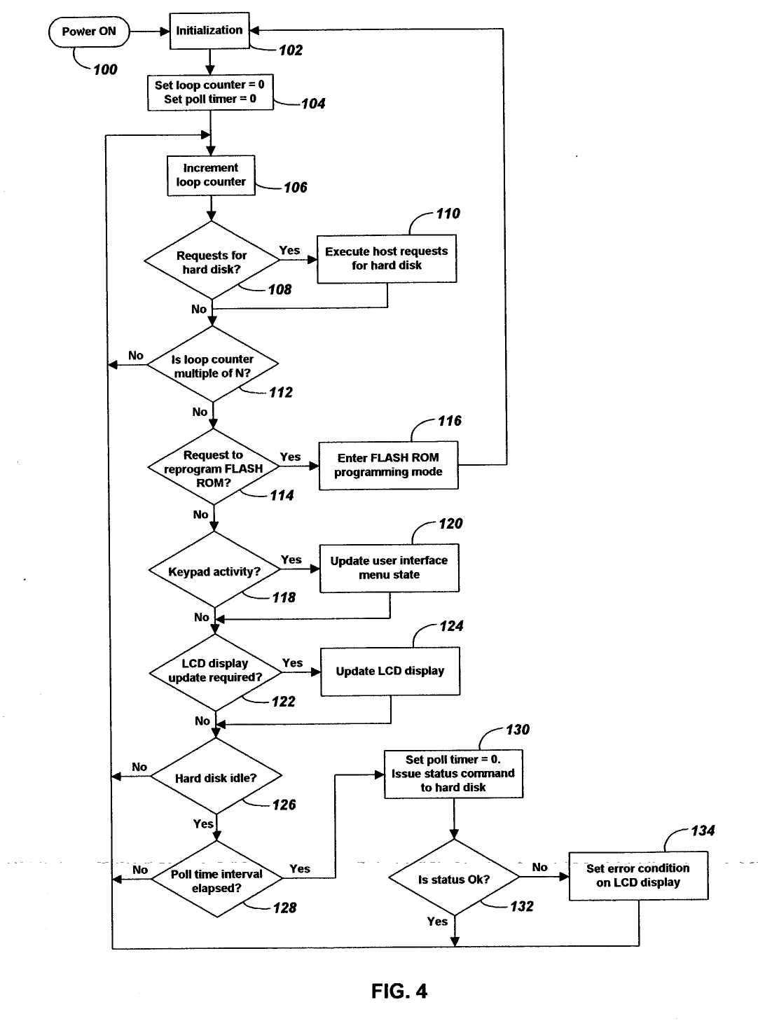

Operation is controlled by CPU 42 as it executes program code stored in FLASH ROM 48. FIG. 4 is a flow chart illustrating the operation of CPU 42 in the preferred embodiment.

After completing an initial power ON initialization (steps 100, 102, 104), CPU 42 enters a continuous loop. On each pass through this loop, CPU 42 increments a loop counter (step 106) and examines each task in a plurality of tasks, determining which tasks have work that is pending.

Tasks are divided into two categories, those tasks which are time-critical and tasks which are not time-critical. Time critical tasks are checked on each pass through the loop, and include:

1. Execute requests from host computer 60 to perform commands on hard disk 30 (steps 108, 110).

Non-time-critical tasks are checked once in every N passes through the loop (step 112), where N is an arbitrary number determined at design time. By performing non-time-critical tasks less frequently than time-critical tasks, the design of the present invention allocates a greater percentage of CPU 42 time to time-critical tasks. Said design also has the effect of reducing the average latency time for CPU 42 to respond to time-critical tasks. Non-time-critical tasks include:

2. Execute requests from host computer 60 to enter FLASH ROM programming mode (steps 114, 116).

3. Respond to actuation of buttons 16 and update user interface menu state (steps 118, 120).

4. Update LCD display 16 (steps 122, 124).

5. If hard disk 30 is idle, and if a pre-determined time interval has elapsed, issue a command to hard disk 30 to check its status (steps 126, 128, 130, 132, 134).

Each of these tasks is discussed in the following sections.

### EXECUTE REQUESTS FROM HOST COMPUTER ON HARD DISK

The principal application of the present invention is to serve as a storage device for a computer system. As such, the present invention responds to a series of read, write, and configuration requests from the host computer. Said write and read requests accomplish the recording and re-reading of data, respectively. Said configuration requests may perform any of a number of actions, including, but not limited to, querying the type and capacity of hard disk device 30, causing hard disk device 30 to spin up or down in order to manage power consumption, and verifying the integrity of data stored on hard disk device 30,

Bridge controller 32 accepts said read, write, and configuration requests in a first request format from a host computer 60 as transmitted across 1394 bus 62. Bridge controller 32 translates said requests in a first request format into requests in a second request format acceptable to hard disk device 30. Bridge controller 32 then manages the flow of data between host computer 60 and hard disk device 30 to complete said requests.

The majority of said requests are read and write requests to transfer data between host computer 60 and hard disk device 30. High data transfer throughput is an important factor considered by computer operators in selecting and deploying storage devices. Therefore, the design of the present invention is optimized so that CPU 42 favors the execution of requests from host computer 60 over other tasks. Said favoring is accomplished by checking for and executing pending host requests more frequently than other tasks.

### FLASH ROM PROGRAMMING MODE

Bridge controller 32 is capable of responding to requests from host computer 60 to enter a mode in which the FLASH ROM 48 can be reprogrammed, called FLASH ROM programming mode. During the execution of FLASH ROM programming mode (step 116), integrated circuit 40 disables CPU 42. Therefore, FLASH ROM programming mode precludes the execution of other tasks.

While executing FLASH ROM programming mode, integrated circuit 40 accepts requests from host computer 60 to erase FLASH ROM 48 and to store new program code into FLASH ROM 48. After transmitting a complete set of new program code to integrated circuit 40, host computer 60 sends a reset request to integrated circuit 40. In response to said reset request, integrated circuit 40 resets itself, at which time CPU 42 begins execution of said new program code, beginning with power ON initialization (step 102).

Said new program code may fix errors in the original program code or it may add new features not present in the original program code. By adding new features, new program code may alter the manner in which the bridge controller 32 responds to input from the computer operator through buttons 14 and it may alter the manner in which bridge controller 32 updates LCD display 16. In this way, the operation of the user interface as perceived by the computer operator can be changed or enhanced, even for units already in the field.

New program code may be transferred or distributed by any computer-readable media. Such computer-readable media may be those specifically designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Computer-readable media may also be program code transmitted by a computer data signal embodied in a carrier wave and representing a sequence of instructions that are executable by a processor.

### UPDATE USER INTERFACE MENU STATE

The information displayed on LCD display 16 is determined at any given time by state information maintained by CPU 42 in RAM 50. Said states are termed menu states. For each menu state CPU 42 will cause LCD display 16 to present particular information to the computer operator. For some menu states CPU 42 causes LCD display 16 to display static, that is to say unchanging, information. A copyright notice displayed during power ON initialization is an example of static information. For other menu states CPU 42 causes LCD display 16 to display dynamic, that is to say changeable, information. The average data transfer performance over the preceding ½ second time interval, expressed as bytes per second, is an example of dynamic information.

CPU 42 recognizes the actuation of buttons 14 by reading button closure status from FPGA 52. When CPU 42 determines that any of buttons 14 has been newly actuated it examines the current menu state and in some cases it also examines other data stored in RAM 50. For the actuation of a specific button among buttons 14, the current menu state, possibly combined with other data stored in RAM 50, determines the identity of one and only one new menu state. If the new menu state is different than the current menu state, CPU 42 changes the current menu state to the new menu state and causes LCD 16 to display new information.

### UPDATE LCD

The interface between FPGA 52 and LCD display 16 operates at a much lower rate than the speed at which CPU 42 can calculate new information to be displayed on LCD display 16. For example, in the preferred embodiment, it may take 40 microseconds or more to transfer each character from FPGA 52 to LCD display 16. Therefore, updating all 40 positions in LCD display 16 in the preferred embodiment could require at least 1.6 milliseconds (40 characters×40 microseconds/character). If CPU 42 were required to suspend processing of other tasks during each display update, then the performance of said other tasks would be adversely affected. In particular, processing of host computer 60 requests for hard disk 30 would be adversely affected.

In order to overcome this problem, CPU 42 uses a display buffer stored in RAM 50 and a two-step display update process. The display buffer in RAM 50 has storage for each character location on LCD display 16. In the preferred embodiment, LCD display 16 is a 2 line×20 character display, so said display buffer has room for 40 characters. Said display buffer also maintains a binary flag for each character position in the display buffer. Said flag indicates whether or not the data stored in the corresponding character location in the display buffer has been written.to LCD display 16. Said flag is set to a value of “1” if the data in the corresponding character position in the display buffer has not yet been written to LCD display 16. Said flag is reset to “0” when the data stored in the corresponding character position in the display buffer has been written to LCD display 16.

When CPU 42 needs to write new information to LCD display 16, it does so in a two-step process. In the first step, CPU 42 calculates new information to be displayed and writes said new information to the display buffer stored in RAM 50. Said calculation of display information and said writing of display information to the display buffer is a rapid process that can be accomplished in real-time without adversely affecting the processing of other tasks. The flag corresponding to each newly written character in the display buffer is set to “1” to indicate that said character has not yet been written to LCD display 16.

CPU 42 performs the second step of the display update process in display update increments, performing exactly one such display update increment on each pass through the main work loop illustrated in FIG. 4. Display update increments are designed so that a given display update increment can be executed without causing CPU 42 to pause while executing a polling loop.

For example, the update of a single character position in LCD display 16 is one such display update increment. During said increment CPU 42 checks if LCD display 16 is ready to accept a new character by reading the current status of LCD display 16 from FPGA 52. If LCD display 16 is ready to accept a new character, CPU 42 writes the character to FPGA 52 which in turn transmits the character to LCD display 16. Then CPU 42 sets the flag corresponding to this character's position in the display buffer to “0”, and advances to the next character position in the display buffer. If LCD display 16 is not ready to accept a new character, CPU 42 immediately terminates the current display update increment and proceeds with other tasks.

In addition to processing display update increments, step 124 incorporates a second activity, the recalculation of dynamic display information. If the current menu state requires the display of dynamic information, then CPU 42 periodically recalculates the dynamic information to be displayed on LCD display 16. For example, if the current menu state requires the display of real-time data transfer performance, CPU 42 will calculate new display information and write it to the display buffer in RAM 50 as described previously.

### PERFORM PERIODIC, IDLE TIME STATUS CHECK OF HARD DISK

On a periodic basis and if hard disk device 30 is idle, CPU 42 will autonomously send a command to hard disk device 30 to request current reliability status information. If said reliability status information is Ok, then CPU 42 continues to the next task. If said reliability status information indicates an error, then CPU 42 records the error condition in RAM 50 and changes the menu state to an error menu state. Said error menu state requires the display of dynamic information; so in step 124, CPU 42 calculates display information that causes an error message to flash periodically on LCD display 16.

In this manner the present invention presents a highly visible warning to the computer operator that there is a pending reliability problem with hard disk device 30.

### OTHER USER INTERFACE CAPABILITIES

As described earlier, information displayed on LCD display 16 is organized according to menu states, wherein the information displayed depends on the current menu state and transitions from a current menu state to a new menu state can be effected by the computer operator through the actuation of buttons 14.

The preferred embodiment of the present invention implements numerous menus offering a range of capabilities to the user. Menu states may be roughly divided into five categories: real-time status, a main menu, a diagnostic menu, a SMART menu, and a screen saver.

Upon power ON, the preferred embodiment defaults to real-time status. In the preferred embodiment there are three such real-time status states: operating status, real-time data transfer performance, and real-time input/output command performance. Operating status notifies the user when an important event occurs, such as the attachment of a host computer, the removal of the 1394 cable, and so forth. Real-time data transfer performance and real-time input/output command performance display calculated metrics of performance as the average value over the preceding ½ second interval and the peak value observed since power ON. The computer operator can cycle LCD display 16 among the three real-time status states using the button marked “Select”.

Using various combinations of the “Menu” and “Select” buttons, the computer operator can invoke the main menu, the diagnostic menu, and the SMART menu.

The main menu provides selections which display static information about the bridge controller, static information about the attached hard disk device, dynamic information about the state of 1394 cable connections to bridge controller 32, and dynamic information about one or more host computers 60 currently communicating with the bridge controller 32. The main menu also includes a selection to invoke the diagnostic menu.

The diagnostic menu provides selections to perform read, verify, and write/erase tests on the hard disk device. When one of these selections is invoked by the user, the CPU 42 sends read, verify, or write commands to hard disk 30 as indicated by the chosen test. The diagnostic menu also includes a selection to invoke the SMART menu.

The SMART menu provides selections related to the industry standard S.M.A.R.T. (Self-Monitoring, Analysis, and Reporting Technology) for ATA hard disks. The S.M.A.R.T. specification defines mechanisms by which a hard disk can report its internal reliability data to a host computer. In the context of the present invention, bridge controller 32 acts in place of said host computer for the purposes of receiving S.M.A.R.T. reliability data from the hard disk device. The SMART menu provides selections to enable or disable S.M.A.R.T., to view status related to S.M.A.R.T., to view S.M.A.R.T. error logs recorded by hard disk device 30, and to initiate S.M.A.R.T. self tests in hard disk device 30.

CPU 42 automatically switches to a screen saver menu state when there has been no activity on hard disk device 30 and no actuation of buttons 14 for more than 60 seconds. When CPU 42 switches to the screen saver menu state it saves the current menu state. Any actuation of buttons 14 while in the screen saver state causes CPU 42 to restore the saved menu state. Any resumption of activity on hard disk device 30 while in the screen saver state causes CPU 42 to restore the saved menu state if and only if the saved menu state is a real-time status state.

In typical usage, the computer operator will allow LCD display 16 to display realtime status or the screen saver. If there is a need to configure or troubleshoot the hard disk device 30 or the bridge controller 32, then the computer operator will select the appropriate menu states using a combination of “Menu” and “Select” buttons 14. In particular, if a reliability status error is detected and reported (step 130, 132, 134), the computer operator is likely to select either the diagnostic or SMART menu in order to perform further diagnosis of the fault.

### CONCLUSION

The integration of a user interface directly in the design of a hard disk enclosure provides an apparatus by which a computer operator can interact directly with the hard disk device, and many benefits accrue from such direct interaction. The reliability and performance of the hard disk device can be communicated directly to the computer operator without the need for custom software running on a host computer. The computer operator can directly configure and troubleshoot the operation of the hard disk device, also without the need for custom software on the host computer.

The availability of a dedicated user interface for the hard disk device provides a foundation on which future hard disk applications can be deployed and creates a new paradigm for the deployment of storage-related applications. Such applications can be implemented relying on the user interface capabilities of the device, in many cases rendering them independent of the host computer and host operating system platform.

It will be apparent to one skilled in the art that the hard disk enclosure may take any of many physical forms. In the preferred embodiment illustrating herein, the hard disk enclosure is an external case made of injection-molded ABS plastic. In alternate embodiments, the hard disk enclosure could be fabricated in other plastic materials, in metal, etc. In still further embodiments, the enclosure could be designed for mounting within the computer itself, perhaps conforming to the form-factor and mounting points of a standard 5.25″ hard disk device itself designed to house a smaller 3.5″ hard disk device.

It will also be apparent to one skilled in the art that integrated circuit 40 may be replaced by other integrated circuits or combinations of integrated circuits. It will also be apparent that CPU 42, FLASH ROM 48, and RAM 50 are representative of general electronic circuit building blocks and may be replaced by equivalent electronic circuits.

It will also be apparent to one skilled in the art that the bridge controller may communicate with the hard disk device through any of several hard disk interfaces, including but not limited to, ATA, SCSI, and Fibre Channel.

It will also be apparent to one skilled in the art that the bridge controller may communicate with the computer system through any of several interface buses, including but not limited to, 1394, USB, ATA, SCSI, and Fibre Channel. It will also be apparent to one skilled in the art that the bridge controller may communicate with the hard disk device and the host computer system using the same bus interface.

It will also be apparent to one skilled in the art that the function of the bridge controller may be integrated directly into the hard disk device without departing from the spirit or scope of the present invention.

It will also be apparent to one skilled in the art that the size of the LCD display and the number of buttons incorporated in the user interface module may vary without departing from the scope of the present invention. It will also be apparent that other forms of displays, such as bitmap graphic displays, could be substituted for the LCD display so long as these displays are capable of producing human-readable characters. It will also be apparent that other forms of switches could be substituted for buttons.

While the present invention has been described in terms of a preferred embodiment, there are alterations, permutations, and substitute equivalents which fall within the scope of this invention. While some of these alterations, permutations, and equivalents have been listed above, it should be noted that there are many alternative ways of implementing the apparatus and methods of the present invention. It is therefore intended that the following appended claims be interpreted as including all such alterations, permutations, and substitute equivalents as fall within the true spirit and scope of this invention.

What is claimed is:

1. A hard disk enclosure for mounting a hard disk device and for connecting said hard disk device to a computer, comprising:
(a) a display device capable of displaying human-readable characters;
(b) one or more switches capable of being actuated by an operator;
(c) a controller capable of controlling said display device, of detecting actuation of said switches, of communicating with said hard disk device, of communicating with said host computer through a bus interface, and of transferring data between said hard disk device and said host computer.

2. The hard disk enclosure of claim 1 wherein the display device is an LCD display.

3. The hard disk enclosure of claim 1 wherein the switches are fabricated as buttons which are integral to a membrane keypad.

4. The hard disk enclosure of claim 1 wherein the hard disk device is an ATA hard disk.

5. The hard disk enclosure of claim 1 wherein the bus interface is a IEEE-1394 bus.

6. The hard disk enclosure of claim 1 wherein the controller is a 1394-ATA bridge controller.

7. The hard disk enclosure of claim 1, further comprising:
(a) program code for displaying real-time hard disk device status or performance data.

8. The hard disk enclosure of claim 1, further comprising:
(a) program code for displaying data read from the hard disk device.

9. The hard disk enclosure of claim 1, further comprising:
(a) program code for displaying a menu selection from a plurality of menu selections based on a currently selected menu state.

10. The hard disk enclosure of claim 9, further comprising:
(a) program code for detecting switch actuation;
(b) program code for causing said switch actuation to trigger the calculation of a new menu state.

11. The hard disk enclosure of claim 1, further comprising:
(a) program code for periodically issuing commands to the hard disk device to check hard disk device reliability status;
(b) program code for displaying a warning message if said hard disk device reliability status indicates a problem with the device.

12. The hard disk enclosure of claim 1, further comprising:
(a) program code or circuitry for allowing the reprogramming of the ROM containing program code.
